(19) United States
(12) Patent Application Publication
(10) Pub. No.: US 2022/0052735 A1
(43) Pub. Date: Feb. 17, 2022

(54) TECHNIQUES FOR BUNDLING CHANNEL STATE INFORMATION (CSI) FEEDBACK IN WIRELESS COMMUNICATIONS

(71) Applicant: QUALCOMM Incorporated, San Diego, CA (US)

(72) Inventors: Wei YANG, San Diego (US); Wanshi CHEN, San Diego, CA (US); Yi HUANG, San Diego, CA (US); Peter GAAL, San Diego, CA (US); Hwan Joon KWON, San Diego, CA (US); Krishna Kiran MUKKAVILLI, San Diego, CA (US); Tao LUO, San Diego, CA (US); Xiaoxia ZHANG, San Diego, CA (US); Yan ZHOU, San Diego, CA (US)

(21) Appl. No.: 17/399,764

(22) Filed: Aug. 11, 2021

Related U.S. Application Data
(60) Provisional application No. 63/066,616, filed on Aug. 17, 2020.

(51) Int. Cl. H04B 7/06; H04L 1/18; H04W 72/14; H04W 24/10

(52) U.S. Cl. CPC H04B 7/0626; H04W 24/10; H04W 72/14; H04L 1/1893

(57) ABSTRACT

Aspects described herein relate to receiving two or more downlink transmissions, determining, for each of the two or more downlink transmissions, channel state information (CSI) feedback, generating a joint CSI feedback report that jointly encodes the CSI feedback for each of the two or more downlink transmissions and is of a reduced size from the CSI feedback for the two or more downlink transmissions, and transmitting the joint CSI feedback report. Other aspects relate to transmitting the two or more downlink transmissions and processing the joint CSI feedback report.

### CLAIM OF PRIORITY UNDER 35 U.S.C. § 119

The present Application for Patent claims priority to Provisional Patent Application No. 63/066,616, entitled “TECHNIQUES FOR BUNDLING CHANNEL STATE INFORMATION (CSI) FEEDBACK IN WIRELESS COMMUNICATIONS” filed Aug. 17, 2020, which is assigned to the assignee hereof and hereby expressly incorporated by reference herein for all purposes.

### BACKGROUND

Aspects of the present disclosure relate generally to wireless communication systems, and more particularly, to reporting channel state information (CSI).

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as 5G new radio (5G NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect, an apparatus for wireless communication is provided that includes a transceiver, a memory configured to store instructions, and one or more processors communicatively coupled with the memory and the transceiver. The one or more processors are configured to execute the instructions to cause the apparatus to receive, from a base station, two or more downlink transmissions, determine, for each of the two or more downlink transmissions, channel state information (CSI) feedback, generate a joint CSI feedback report that jointly encodes the CSI feedback for each of the two or more downlink transmissions and is of a reduced size from the CSI feedback for the two or more downlink transmissions, and transmit, to the base station, the joint CSI feedback report.

According to another aspect, an apparatus for wireless communication is provided that includes a transceiver, a memory configured to store instructions, and one or more processors communicatively coupled with the memory and the transceiver. The one or more processors are configured to execute the instructions to cause the apparatus to transmit, to a user equipment (UE), two or more downlink transmissions, receive, from the UE, a joint CSI feedback report indicating a CSI feedback for each of the two or more downlink transmissions, wherein the joint CSI feedback report is of a reduced size from the CSI feedback for the two or more downlink transmissions; and process the joint CSI feedback report to determine the CSI feedback for each of the two or more downlink transmissions.

According to another aspect, a method of wireless communication is provided. The method includes receiving, from a base station, two or more downlink transmissions, determining, for each of the two or more downlink transmissions, CSI feedback, generating a joint CSI feedback report that jointly encodes the CSI feedback for each of the two or more downlink transmissions and is of a reduced size from the CSI feedback for the two or more downlink transmissions, and transmitting, to the base station, the joint CSI feedback report.

According to another aspect, a method of wireless communication is provided. The method includes transmitting, to a UE, two or more downlink transmissions, receiving, from the UE, a joint CSI feedback report indicating a CSI feedback for each of the two or more downlink transmissions, wherein the joint CSI feedback report is of a reduced size from the CSI feedback for the two or more downlink transmissions, and processing the joint CSI feedback report to determine the CSI feedback for each of the two or more downlink transmissions.

In a further example, an apparatus for wireless communication is provided that includes a transceiver, a memory configured to store instructions, and one or more processors communicatively coupled with the transceiver and the memory. The one or more processors are configured to execute the instructions to perform the operations of methods described herein. In another aspect, an apparatus for wireless communication is provided that includes means for performing the operations of methods described herein. In yet another aspect, a computer-readable medium is provided including code executable by one or more processors to perform the operations of methods described herein.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communication system, in accordance with various aspects of the present disclosure;

FIG. 2 is a block diagram illustrating an example of a UE, in accordance with various aspects of the present disclosure;

FIG. 3 is a block diagram illustrating an example of a base station, in accordance with various aspects of the present disclosure;

FIG. 4 is a flow chart illustrating an example of a method for generating a joint channel state information (CSI) feedback report, in accordance with various aspects of the present disclosure;

FIG. 5 is a flow chart illustrating an example of a method for processing a joint CSI feedback report, in accordance with various aspects of the present disclosure; and

FIG. 6 is a block diagram illustrating an example of a MIMO communication system including a base station and a UE, in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

In fifth generation (5G) new radio (NR), a user equipment (UE) can be configured to generate and transmit channel state information (CSI) feedback to a base station to indicate various feedback of communications from a base station. The base station can schedule the UE, using an uplink grant, to transmit an aperiodic CSI report (A-CSI) on an uplink channel, such as physical uplink shared channel (PUSCH). The UE can measure A-CSI on CSI-reference signals (CSI-RS) or indicated CSI-interference management (CSI-IM) resources. In another example, the base station can trigger the UE to measure CSI on dedicated CSI-RS or a downlink channel, such as physical downlink shared channel (PDSCH), and send CSI feedback on an uplink channel, such as physical uplink control channel (PUCCH).

The described features generally relate to generating and transmitting CSI feedback for multiple downlink transmissions, where the multiple downlink transmissions can include CSI-RS transmissions, PDSCH transmissions (e.g., as scheduled by a corresponding downlink grant), or other transmissions. As described herein, CSI can generally refer to information related to downlink channel quality, which may be or include one or more of a CSI reference signal resource indicator (CRI), a rank indicator (RI), a precoding matrix indicator (PMI), or a channel quality indicator (CQI). Thus, for example, a UE can measure CSI feedback for each of multiple downlink transmissions, and can report the CSI feedback, or values representing the CSI feedback for each or for one or more of the multiple downlink transmissions, as described herein. In an example, the CSI feedback for each of the multiple downlink transmissions can be bundled into a joint CSI feedback report that is of a reduced size (e.g., a less number of total bits than the collection of CSI feedback for the multiple downlink transmissions).

For example, the base station can indicate, in a downlink grant, one or more parameters related to CSI reporting, such as for reporting CSI feedback of one or more CSI-RSs and/or of one or more PDSCH transmissions received in different time periods. The UE can accordingly receive the one or more parameters, the CSI-RS(s) and/or PDSCH transmission(s), and can measure CSI and transmit the joint CSI feedback report for the various transmissions. In one example, the UE can jointly encode CSI along with other feedback, such as hybrid automatic repeat/request (HARD) acknowledgment (ACK)/negative-ACK (NACK) feedback. In one example, the jointly encoded ACK and CSI feedback may indicate ACK or NACK along with a CSI value, such as ACK with high margin, ACK with low margin (e.g., transmission barely succeeds), NACK with good channel conditions, NACK with bad channel conditions (e.g., need more resources for retransmissions), etc. This can be referred to as a super-HARQ-ACK or soft-HARQ-ACK.

In any case, for example, a UE can be scheduled to multiplex multiple HARQ-ACK bits in the same slot for transmitting to the base station (e.g., over PUCCH resources. The UE can determine CSI feedback for each of multiple downlink transmissions received in different time periods, such as in different symbols (e.g., orthogonal frequency division multiplexing (OFDM) symbols, single carrier-frequency division multiplexing (SC-FDM) symbols, etc.) of a slot of multiple symbols, different slots, etc. The UE can then multiplex the CSI feedback into a joint CSI feedback report that is condensed when compared to the collection of CSI feedback. This can reduce overhead required to send the CSI feedback for each of the multiple downlink transmissions, which can improve throughput and/or quality of wireless communications between a UE and base station (or other devices). In an example, the base station can configure the UE to transmit the CSI feedback as the joint CSI feedback report.

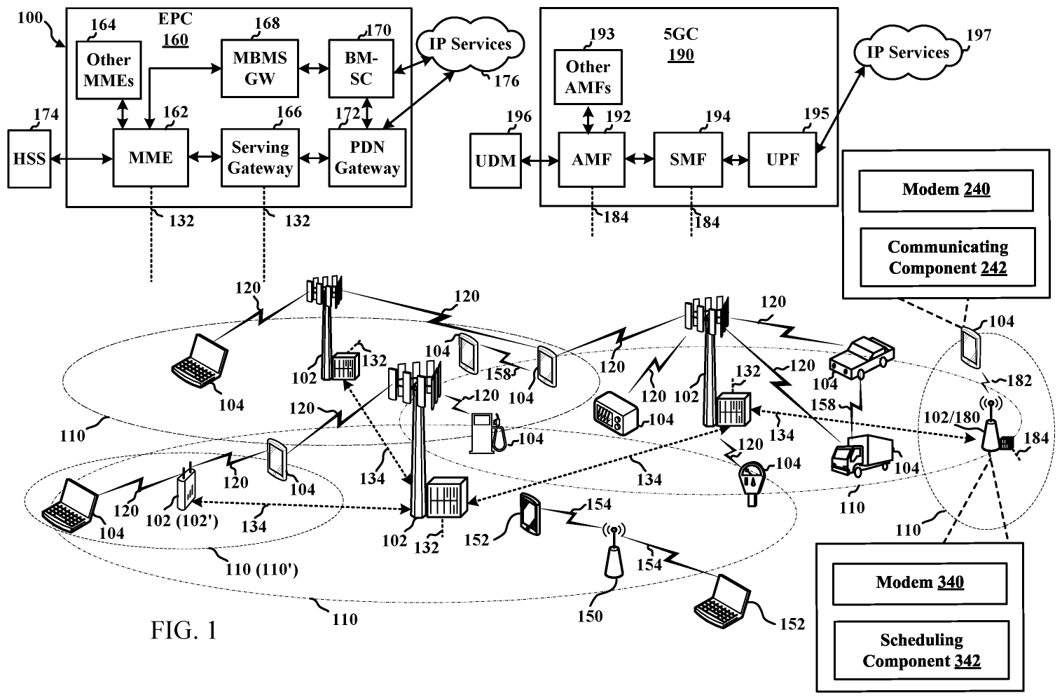

The described features will be presented in more detail below with reference to FIGS. 1-6.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

Techniques described herein may be used for various wireless communication systems such as CDMA, TDMA, FDMA, OFDMA, SC-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to fifth generation (5G) new radio (NR) networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102 may include macro cells (high power cellular base station) and/or small cells (low power cellular base station). The macro cells can include base stations. The small cells can include femtocells, picocells, and microcells. In an example, the base stations 102 may also include gNBs 180, as described further herein. In one example, some nodes of the wireless communication system may have a modem 240 and communicating component 242 for generating and transmitting joint CSI feedback reports for multiple received transmissions, in accordance with aspects described herein. In addition, some nodes may have a modem 340 and scheduling component 342 for scheduling devices for receiving transmissions and reporting joint CSI feedback reports for multiple transmissions, in accordance with aspects described herein. Though a UE 104 is shown as having the modem 240 and communicating component 242 and a base station 102/gNB 180 is shown as having the modem 340 and scheduling component 342, this is one illustrative example, and substantially any node or type of node may include a modem 240 and communicating component 242 and/or a modem 340 and scheduling component 342 for providing corresponding functionalities described herein.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (e.g., using an S1 interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 134 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152 AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range. A base station 102 referred to herein can include a gNB 180.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). IoT UEs may include machine type communication (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

In an example, communicating component 242 can receive multiple downlink transmissions from one or more base stations 102 or related cells 110 in different time periods. The communicating component 242 can determine CSI feedback for each of the multiple downlink transmissions and can generate and transmit, for the multiple downlink transmissions, a joint CSI feedback report that is reduced in size from the collection of CSI feedback. Scheduling component 342 can receive the joint CSI feedback report and can process the report to determine CSI feedback for one or more of the multiple downlink transmissions. Scheduling component 342 can use the CSI feedback to determine a subsequent downlink transmission (e.g., whether to retransmit one or more of the multiple downlink transmission or transmit a new downlink transmission, etc.

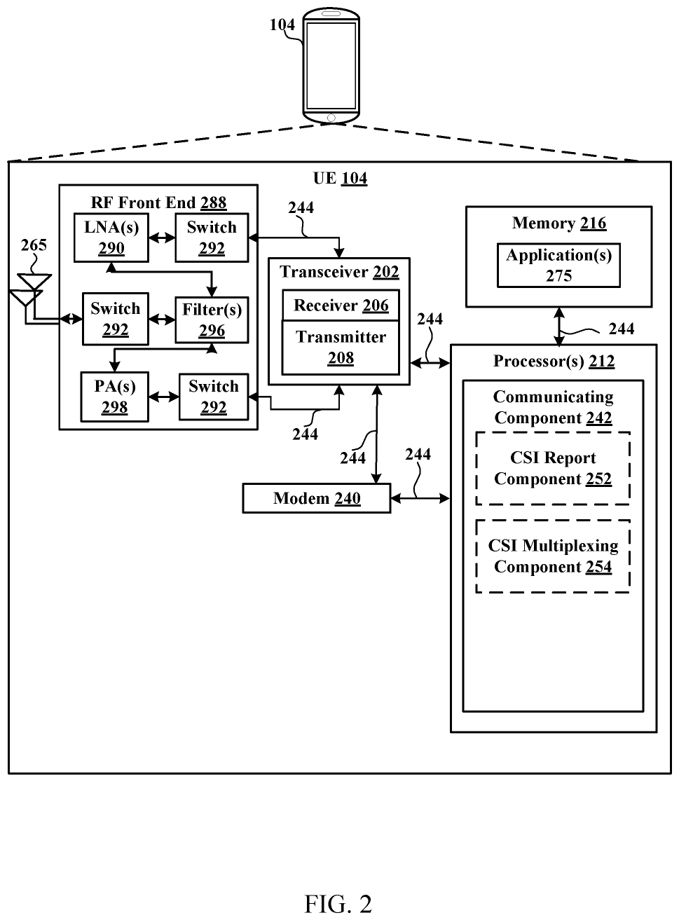

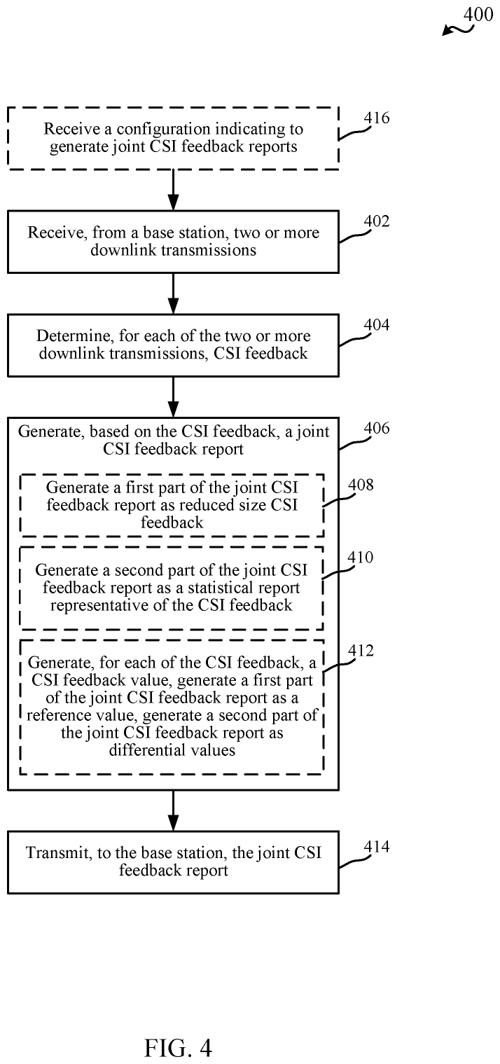

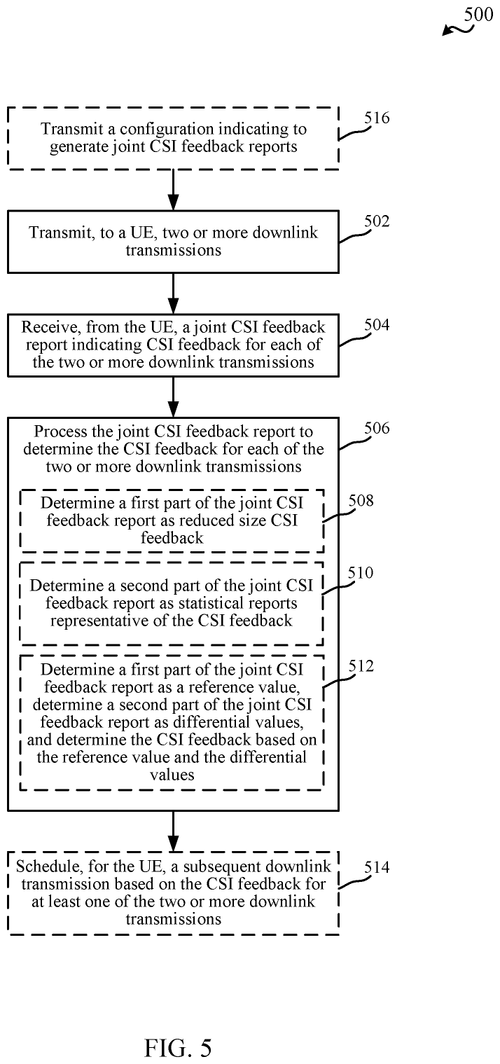

Turning now to FIGS. 2-6, aspects are depicted with reference to one or more components and one or more methods that may perform the actions or operations described herein, where aspects in dashed line may be optional. Although the operations described below in FIGS. 4-5 are presented in a particular order and/or as being performed by an example component, it should be understood that the ordering of the actions and the components performing the actions may be varied, depending on the implementation. Moreover, it should be understood that the following actions, functions, and/or described components may be performed by a specially programmed processor, a processor executing specially programmed software or computer-readable media, or by any other combination of a hardware component and/or a software component capable of performing the described actions or functions.

Referring to FIG. 2, one example of an implementation of UE 104 may include a variety of components, some of which have already been described above and are described further herein, including components such as one or more processors 212 and memory 216 and transceiver 202 in communication via one or more buses 244, which may operate in conjunction with modem 240 and/or communicating component 242 for generating and transmitting joint CSI feedback reports for multiple received transmissions, in accordance with aspects described herein.

In an aspect, the one or more processors 212 can include a modem 240 and/or can be part of the modem 240 that uses one or more modem processors. Thus, the various functions related to communicating component 242 may be included in modem 240 and/or processors 212 and, in an aspect, can be executed by a single processor, while in other aspects, different ones of the functions may be executed by a combination of two or more different processors. For example, in an aspect, the one or more processors 212 may include any one or any combination of a modem processor, or a baseband processor, or a digital signal processor, or a transmit processor, or a receiver processor, or a transceiver processor associated with transceiver 202. In other aspects, some of the features of the one or more processors 212 and/or modem 240 associated with communicating component 242 may be performed by transceiver 202.

Also, memory 216 may be configured to store data used herein and/or local versions of applications 275 or communicating component 242 and/or one or more of its subcomponents being executed by at least one processor 212. Memory 216 can include any type of computer-readable medium usable by a computer or at least one processor 212, such as random access memory (RAM), read only memory (ROM), tapes, magnetic discs, optical discs, volatile memory, non-volatile memory, and any combination thereof. In an aspect, for example, memory 216 may be a non-transitory computer-readable storage medium that stores one or more computer-executable codes defining communicating component 242 and/or one or more of its subcomponents, and/or data associated therewith, when UE 104 is operating at least one processor 212 to execute communicating component 242 and/or one or more of its subcomponents.

Transceiver 202 may include at least one receiver 206 and at least one transmitter 208. Receiver 206 may include hardware, firmware, and/or software code executable by a processor for receiving data, the code comprising instructions and being stored in a memory (e.g., computer-readable medium). Receiver 206 may be, for example, a radio frequency (RF) receiver. In an aspect, receiver 206 may receive signals transmitted by at least one base station 102. Additionally, receiver 206 may process such received signals, and also may obtain measurements of the signals, such as, but not limited to, Ec/Io, signal-to-noise ratio (SNR), reference signal received power (RSRP), received signal strength indicator (RSSI), etc. Transmitter 208 may include hardware, firmware, and/or software code executable by a processor for transmitting data, the code comprising instructions and being stored in a memory (e.g., computer-readable medium). A suitable example of transmitter 208 may including, but is not limited to, an RF transmitter.

Moreover, in an aspect, UE 104 may include RF front end 288, which may operate in communication with one or more antennas 265 and transceiver 202 for receiving and transmitting radio transmissions, for example, wireless communications transmitted by at least one base station 102 or wireless transmissions transmitted by UE 104. RF front end 288 may be connected to one or more antennas 265 and can include one or more low-noise amplifiers (LNAs) 290, one or more switches 292, one or more power amplifiers (PAs) 298, and one or more filters 296 for transmitting and receiving RF signals.

In an aspect, LNA 290 can amplify a received signal at a desired output level. In an aspect, each LNA 290 may have a specified minimum and maximum gain values. In an aspect, RF front end 288 may use one or more switches 292 to select a particular LNA 290 and its specified gain value based on a desired gain value for a particular application.

Further, for example, one or more PA(s) 298 may be used by RF front end 288 to amplify a signal for an RF output at a desired output power level. In an aspect, each PA 298 may have specified minimum and maximum gain values. In an aspect, RF front end 288 may use one or more switches 292 to select a particular PA 298 and its specified gain value based on a desired gain value for a particular application.

Also, for example, one or more filters 296 can be used by RF front end 288 to filter a received signal to obtain an input RF signal. Similarly, in an aspect, for example, a respective filter 296 can be used to filter an output from a respective PA 298 to produce an output signal for transmission. In an aspect, each filter 296 can be connected to a specific LNA 290 and/or PA 298. In an aspect, RF front end 288 can use one or more switches 292 to select a transmit or receive path using a specified filter 296, LNA 290, and/or PA 298, based on a configuration as specified by transceiver 202 and/or processor 212.

As such, transceiver 202 may be configured to transmit and receive wireless signals through one or more antennas 265 via RF front end 288. In an aspect, transceiver may be tuned to operate at specified frequencies such that UE 104 can communicate with, for example, one or more base stations 102 or one or more cells associated with one or more base stations 102. In an aspect, for example, modem 240 can configure transceiver 202 to operate at a specified frequency and power level based on the UE configuration of the UE 104 and the communication protocol used by modem 240.

In an aspect, modem 240 can be a multiband-multimode modem, which can process digital data and communicate with transceiver 202 such that the digital data is sent and received using transceiver 202. In an aspect, modem 240 can be multiband and be configured to support multiple frequency bands for a specific communications protocol. In an aspect, modem 240 can be multimode and be configured to support multiple operating networks and communications protocols. In an aspect, modem 240 can control one or more components of UE 104 (e.g., RF front end 288, transceiver 202) to enable transmission and/or reception of signals from the network based on a specified modem configuration. In an aspect, the modem configuration can be based on the mode of the modem and the frequency band in use. In another aspect, the modem configuration can be based on UE configuration information associated with UE 104 as provided by the network during cell selection and/or cell reselection.

In an aspect, communicating component 242 can optionally include a CSI report component 252 for generating a CSI report for each of multiple downlink transmissions, and/or a CSI multiplexing component 254 for generating a joint CSI report representative of the multiple CSI feedback reports for the multiple downlink transmissions, in accordance with aspects described herein.

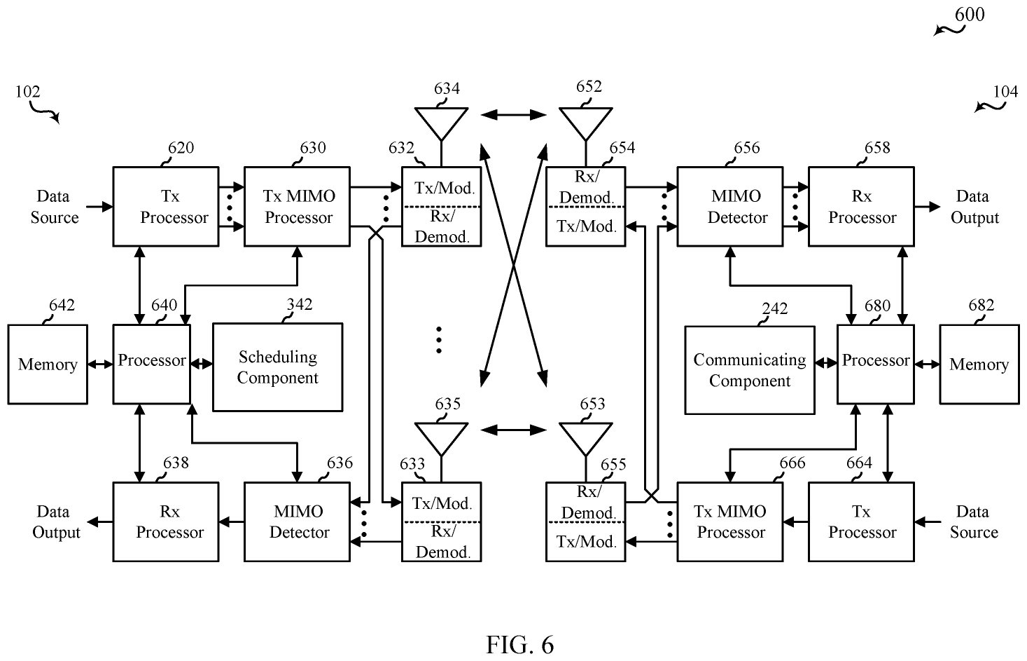

In an aspect, the processor(s) 212 may correspond to one or more of the processors described in connection with the UE in FIG. 6. Similarly, the memory 216 may correspond to the memory described in connection with the UE in FIG. 6.

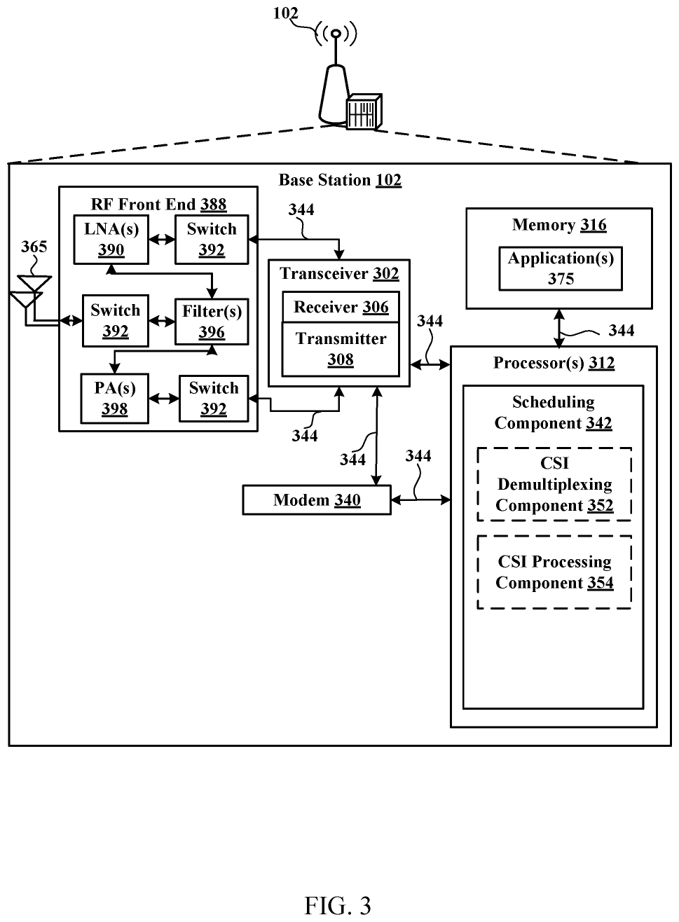

Referring to FIG. 3, one example of an implementation of base station 102 (e.g., a base station 102 and/or gNB 180, as described above) may include a variety of components, some of which have already been described above, but including components such as one or more processors 312 and memory 316 and transceiver 302 in communication via one or more buses 344, which may operate in conjunction with modem 340 and scheduling component 342 for scheduling devices for receiving transmissions and reporting joint CSI feedback reports for multiple transmissions, in accordance with aspects described herein.

The transceiver 302, receiver 306, transmitter 308, one or more processors 312, memory 316, applications 375, buses 344, RF front end 388, LNAs 390, switches 392, filters 396, PAs 398, and one or more antennas 365 may be the same as or similar to the corresponding components of UE 104, as described above, but configured or otherwise programmed for base station operations as opposed to UE operations.

In an aspect, scheduling component 342 can optionally include a CSI demultiplexing component 352 for determining multiple CSI feedback reports from a joint CSI feedback report, and/or a CSI processing component 354 for processing the multiple CSI feedback reports to determine a subsequent downlink transmission, in accordance with aspects described herein.

In an aspect, the processor(s) 312 may correspond to one or more of the processors described in connection with the base station in FIG. 6. Similarly, the memory 316 may correspond to the memory described in connection with the base station in FIG. 6.

FIG. 4 illustrates a flow chart of an example of a method 400 for generating a joint CSI feedback report representing multiple CSI feedback for multiple downlink transmissions, in accordance with aspects described herein. In an example, a UE 104 can perform the functions described in method 400 using one or more of the components described in FIGS. 1 and 2.

In method 400, at Block 402, two or more downlink transmissions can be received from a base station. In an aspect, communicating component 242, e.g., in conjunction with processor(s) 212, memory 216, transceiver 202, etc., can receive, from the base station (e.g., base station 102), two or more downlink transmissions. For example, the multiple downlink transmissions can be received in different time periods, where the different time periods may include different symbols, which can be in the same or different slots, different slots, or other time divisions defined in a wireless communication technology, such as 5G NR. For example, the multiple downlink transmissions may be received in a burst of downlink transmissions over consecutive or non-consecutive time periods (e.g., consecutive or non-consecutive symbols, slots, etc.). In an example, communicating component 242 can receive the multiple downlink transmissions from different base stations or different serving cells of one or more base stations, and/or the like. In addition, in an example, communicating component 242 can be scheduled to receive the multiple downlink transmissions, which can be indicated in a resource grant from one or more base stations for resources for receiving downlink transmissions. The downlink transmissions can include one or more CSI-RSs, one or more PDSCH transmissions, and/or the like. In one example, the downlink transmissions and/or control data for the downlink transmissions can indicate that the UE 104 is to measure CSI and report CSI feedback for the downlink transmission (e.g., over PUCCH resources).

In method 400, at Block 404, CSI feedback can be determined for each of the two or more downlink transmissions. In an aspect, CSI report component 252, e.g., in conjunction with processor(s) 212, memory 216, transceiver 202, communicating component 242, etc., can determine, for each of the two or more downlink transmissions, the CSI feedback. Thus, for example, CSI report component 252 can generate multiple CSI feedback, or at least determine associated CSI feedback values that may otherwise be included in a CSI feedback report, where each of the multiple CSI feedback reports or associated values corresponds to one of the multiple downlink transmissions. The CSI feedback reports or values may include one or more values that refer to information related to the downlink data channel link quality, such as CRI, RI, PMI, CQI, etc. In another example, the CSI feedback may indicate other information related to the downlink data quality, such as signal-to-interference-and-noise ratio (SINR), hypothetical and/or estimated block error rate (BLER), etc.

In method 400, at Block 406, a joint CSI feedback report can be generated based on the CSI feedback. In an aspect, CSI multiplexing component 254, e.g., in conjunction with processor(s) 212, memory 216, transceiver 202, communicating component 242, etc., can generate, based on the CSI feedback, the joint CSI feedback report or at least the associated CSI values. For example, CSI multiplexing component 254 can generate the joint CSI feedback report to be reduced in size when compared to the total size of the CSI feedback for the multiple downlink transmissions. In other words, for example, the joint CSI feedback report may be a condensed report that represents the multiple CSI feedback (e.g., the multiple CSI feedback reports or associated values, as described above). In an example, CSI multiplexing component 254 can determine which CSI feedback reports or values to be multiplexed in generating the joint CSI feedback report. For example, CSI multiplexing component 254 can determine to multiplex CSI feedback reports or values for symbols over which downlink transmissions are received in a same slot of symbols. In another example, CSI multiplexing component 254 can determine to multiplex CSI feedback reports or values based on an indication received from the base station 102 (e.g., in a downlink transmission indicating to generate and report the CSI feedback). In yet another example, CSI multiplexing component 254 can determine to multiplex CSI feedback reports or values for downlink transmissions that have not had CSI feedback reported (e.g., the downlink transmissions received since a last CSI feedback report was transmitted to, or scheduled to be transmitted to, the base station 102).

In generating the joint CSI feedback report at Block 406, optionally at Block 408, a first part of the joint CSI feedback report can be generated as reduced size CSI feedback. In an aspect, CSI multiplexing component 254, e.g., in conjunction with processor(s) 212, memory 216, transceiver 202, communicating component 242, etc., can generate the first part of the joint CSI feedback report as reduced size CSI feedback (e.g., where each of the reduced size CSI feedback can correspond to one of the multiple CSI feedback reports or values as determined or generated). For example, CSI multiplexing component 254 can generate the first part of the joint CSI feedback to include CSI for each individual downlink transmission of the multiple downlink transmissions. For example, the first part per-transmission CSI can be intended for the UE 104 to indicate the decoding quality of each downlink transmission. In one example, CSI multiplexing component 254 can generate the first part of the CSI joint feedback report to be HARQ feedback (e.g., an ACK/NACK bit or soft-HARQ-ACK, etc.) for each of the multiple downlink transmissions.

In generating the joint CSI feedback report at Block 406, optionally at Block 410, a second part of the joint CSI feedback report can be generated as a statistical report representative of the CSI feedback. In an aspect, CSI multiplexing component 254, e.g., in conjunction with processor(s) 212, memory 216, transceiver 202, communicating component 242, etc., can generate the second part of the joint CSI feedback report as a statistical report representative of the CSI feedback reports or associated values determined for CSI feedback. For example, CSI multiplexing component 254 can determine the statistical report as one or more values representing a portion of the multiple CSI feedback reports or values. In specific examples, CSI multiplexing component 254 can determine the statistical report as at least one of a number of the worst values of the CSI feedback reports or associated values (e.g., a worst K CQIs among multiple transmissions, where K=1 or 2, etc.), a number of the best values of the CSI feedback reports or associated values (e.g., a best K CQIs among multiple transmissions, where K=1 or 2, etc.), an average of at least a portion of the CSI feedback reports or associated values (e.g., average CQIs among multiple transmissions), at least one of a mean or variance of at least a portion of the CSI feedback reports or associated values (e.g., mean and/or variance CQIs among multiple transmissions), and/or the like. In any case, the total size of the first part and second part of the joint CQI feedback report can be less than that of all CQI feedback reports generated by, or that would otherwise be generated for the determined CSI values by, CSI report component 252.

In another example, in generating the joint CSI feedback report at Block 406, optionally at Block 412, a CSI feedback value can be generated for each of the CSI feedback, a first part of the joint CSI feedback report can be generated as a reference value, and a second part of the joint CSI feedback report can be generated as differential values. In an aspect, CSI multiplexing component 254, e.g., in conjunction with processor(s) 212, memory 216, transceiver 202, communicating component 242, etc., can generate the CSI feedback value for each of the CSI feedback, generate the first part of the joint CSI feedback report as a reference value, and generate the second part of the joint CSI feedback report as differential values. For example, CSI multiplexing component 254 generate CQI values for each CSI feedback report or associated determined CSI value of the multiple downlink transmissions. In this example, CSI multiplexing component 254 can determine a reference value based on the CQI values, such as by determining an average CQI value of the multiple CQI values. For example, the average CQI value can be a median, mean (integer), etc. value of the multiple CQI values. Based on the reference value, CSI multiplexing component 254 can determine the differential values representing each of the multiple CQI values where the differential value represents a difference between the reference value and the corresponding CQI value. In this example (e.g., where the CQI values are within a range of one another), in generating the CSI feedback report, less bits can be consumed at least by using the differential values instead of the determined CQI values. In one specific example, for CQI values=5, 6, 7, 8, 9, CSI multiplexing component 254 can determine a reference value of 7, and corresponding differential values=−2, −1, 0, 1, 2, and can accordingly generate the joint CSI feedback report to indicate the reference value and differential values. This may be an effective approach to reduce the CSI/CQI feedback payload, without sacrificing the quality/information of the feedback.

In method 400, at Block 414, the joint CSI feedback report can be transmitted to the base station. In an aspect, communicating component 242, e.g., in conjunction with processor(s) 212, memory 216, transceiver 202, etc., can transmit, to the base station (e.g., base station 102), the joint CSI feedback report. For example, communicating component 242 can transmit the joint CSI feedback report in indicated PUCCH or PUSCH resources.

In one example, in method 400, optionally at Block 416, a configuration indicating to generate joint CSI feedback reports can be received. In an aspect, communicating component 242, e.g., in conjunction with processor(s) 212, memory 216, transceiver 202, etc., can receive (e.g., from the base station 102) the configuration indicating to generate joint CSI feedback reports, and can generate the joint CSI feedback reports based on receiving the configuration. In one example, the configuration may be received as an indication, in a downlink resource grant (e.g., in downlink control information (DCI) or other a grant of resources over which to receive PDSCH transmission(s)), to generate the joint CSI feedback report (e.g., for the transmission over the PDSCH and/or one or more CSI-RSs). In another example, the configuration may be received in radio resource control (RRC) or other higher layer signaling. The configuration may indicate parameters for generating the joint CSI feedback reports, such as a number or indication of downlink transmissions for which to report CSI feedback, parameters indicating instructions for generating the first and second parts of the joint CSI feedback report, parameters for determining and/or indicating the reference value or differential values, and/or the like. In this example, CSI multiplexing component 254 can multiplex the CSI feedback reports or associated determined CSI values to generate the joint CSI feedback report based on the parameters, and as described above.

FIG. 5 illustrates a flow chart of an example of a method 500 for receiving a joint CSI feedback report representing multiple CSI feedback for multiple downlink transmissions, in accordance with aspects described herein. In an example, a base station 102 can perform the functions described in method 500 using one or more of the components described in FIGS. 1 and 3.

In method 500, at Block 502, two or more downlink transmissions can be transmitted to a UE. In an aspect, scheduling component 342, e.g., in conjunction with processor(s) 312, memory 316, transceiver 302, etc., can transmit, to the UE (e.g., UE 104, two or more downlink transmissions. For example, the multiple downlink transmissions can be transmitted in different time periods (e.g., over different symbols, which can be in the same or different slots, over different slots, etc.). In an example, scheduling component 342 can transmit the multiple downlink transmissions (or at least a portion of the multiple downlink transmissions) in one or more serving cells provided by the base station 102. In another example, other base stations can transmit some of the multiple downlink transmissions. The downlink transmissions can include one or more CSI-RSs, one or more PDSCH transmissions, and/or the like. In one example, scheduling component 342 can generate the downlink transmissions and/or control data for the downlink transmissions to indicate that the UE 104 is to measure and report CSI feedback for the downlink transmission (e.g., over PUCCH resources).

In method 500, at Block 504, a joint CSI feedback report indicating CSI feedback for each of the two or more downlink transmissions can be received. In an aspect, CSI demultiplexing component 352, e.g., in conjunction with processor(s) 312, memory 316, transceiver 302, scheduling component 342, etc., can receive, from the UE, a joint CSI feedback report indicating CSI feedback for each of the two or more downlink transmissions. As described, for example, the joint CSI feedback report can be representative of the CSI feedback (e.g., generated CSI feedback reports or associated determined CSI values) for each of the multiple downlink transmissions, but may be of a reduced size than the collection of CSI feedback for the multiple downlink transmissions. In addition, for example, CSI demultiplexing component 352 can receive the joint CSI feedback report over PUCCH or PUSCH resources granted to the UE 104 for uplink communications.

In method 500, at Block 506, the joint CSI feedback report can be processed to determine the CSI feedback for each of the two or more downlink transmissions. In an aspect, CSI demultiplexing component 352, e.g., in conjunction with processor(s) 312, memory 316, transceiver 302, scheduling component 342, etc., can process the joint CSI feedback report to determine the CSI feedback for each of the two or more downlink transmissions. For example, CSI demultiplexing component 352 can determine which or how many CSI feedback reports, or associated values, are multiplexed in the joint CSI feedback report. For example, CSI demultiplexing component 352 can determine that CSI feedback reports or associated values multiplexed in the joint CSI feedback report are for symbols over which downlink transmissions are transmitted in a same slot of symbols. In another example, CSI demultiplexing component 352 can determine CSI feedback reports or associated values multiplexed in the joint CSI feedback report based on an indication transmitted to the UE 104 (e.g., in a downlink transmission indicating to generate and report the CSI feedback). In yet another example, CSI demultiplexing component 352 can determine CSI feedback reports or associated values multiplexed in the joint CSI feedback report are for downlink transmissions that have not had CSI feedback reported (e.g., the downlink transmissions transmitted since a last CSI feedback report was received from, or scheduled to be received from, the UE 104).

In processing the joint CSI feedback report at Block 506, optionally at Block 508, a first part of the joint CSI feedback report can be determined as reduced size CSI feedback. In an aspect, CSI demultiplexing component 352, e.g., in conjunction with processor(s) 312, memory 316, transceiver 302, scheduling component 342, etc., can determine the first part of the joint CSI feedback report as reduced size CSI feedback. For example, CSI demultiplexing component 352 can determine the first part of the joint CSI feedback as being for each individual downlink transmission of the multiple downlink transmissions. For example, the first part per-transmission CSI can be intended for the UE 104 to indicate the decoding quality of each downlink transmission. In one example, CSI demultiplexing component 352 can determine the first part of the CSI joint feedback report to be HARQ feedback (e.g., an ACK/NACK bit or soft-HARQ-ACK, etc.) for each of the multiple downlink transmissions.

In processing the joint CSI feedback report at Block 506, optionally at Block 510, a second part of the joint CSI feedback report can be determined as a statistical report representative of the CSI feedback. In an aspect, CSI demultiplexing component 352, e.g., in conjunction with processor(s) 312, memory 316, transceiver 302, scheduling component 342, etc., can determine the second part of the joint CSI feedback report as a statistical report representative of the CSI feedback. For example, CSI demultiplexing component 352 can determine the statistical report as one or more values representing a portion of the multiple CSI feedback reports or associated values. In specific examples, CSI demultiplexing component 352 can determine the statistical report as at least one of a number of the worst values of the CSI feedback reports or associated values (e.g., a worst K CQIs among multiple transmissions, where K=1 or 2, etc.), a number of the best values of the CSI feedback reports or associated values (e.g., a best K CQIs among multiple transmissions, where K=1 or 2, etc.), an average of at least a portion of the CSI feedback reports or associated values (e.g., average CQIs among multiple transmissions), at least one of a mean or variance of at least a portion of the CSI feedback reports or associated values (e.g., mean and/or variance CQIs among multiple transmissions), and/or the like. In any case, the total size of the first part and second part of the joint CQI feedback report can be less than that of all CQI feedback reports or associated values.

In another example, in processing the joint CSI feedback report at Block 506, optionally at Block 512, a first part of the joint CSI feedback report can be determined as a reference value, and a second part of the joint CSI feedback report can be determined as differential values, and the CSI feedback can be determined based on the reference value and the differential values. In an aspect, CSI demultiplexing component 352, e.g., in conjunction with processor(s) 312, memory 316, transceiver 302, scheduling component 342, etc., can determine the first part of the joint CSI feedback report as a reference value, determine the second part of the joint CSI feedback report as differential values, and determine the CSI feedback based on the reference value and differential values. For example, CSI demultiplexing component 352 can determine CSI feedback report or associated values for each of the multiple downlink transmissions by applying a corresponding differential value to the reference value to determine the CSI feedback (e.g., to determine a CQI value in the examples described above with respect to Block 412 in FIG. 4).

In the above examples, CSI demultiplexing component 352 can determine the CSI feedback for each of the multiple downlink transmissions based on the joint CSI feedback report, whether the CSI feedback is ACK/NACK for each downlink transmission and a statistical channel quality value, or whether the CSI feedback is a reference value and differential values, etc.

In method 500, optionally at Block 514, a subsequent downlink transmission can be scheduled, for the UE, based on the CSI feedback for one or more of the multiple downlink transmissions. In an aspect, scheduling component 342, e.g., in conjunction with processor(s) 312, memory 316, transceiver 302, etc., can schedule, for the UE, the subsequent downlink transmission based on the CSI feedback for one or more of the multiple downlink transmissions. For example, based on the CSI feedback, scheduling component 342 can determine whether to retransmit one of the multiple downlink transmissions, whether to allocate additional downlink resources for retransmitting the downlink transmission, whether to transmit other subsequent downlink transmissions (e.g., one or more new downlink transmissions), whether to allocate additional downlink resources for transmitting subsequent downlink transmissions, whether to otherwise modify a channel, and/or the like. For example, where the CSI feedback for one or more of the multiple downlink transmissions indicates NACK or a CQI below a threshold, scheduling component 342 can determine to retransmit, to the UE 104, the one or more of the multiple downlink transmissions.

In one example, in method 500, optionally at Block 516, a configuration indicating to generate joint CSI feedback reports can be transmitted. In an aspect, scheduling component 342, e.g., in conjunction with processor(s) 212, memory 216, transceiver 202, etc., can transmit (e.g., to the UE 104) the configuration indicating to generate joint CSI feedback reports. The UE 104 can accordingly generate the joint CSI feedback reports based on receiving the configuration. In one example, the configuration may be transmitted as an indication, in a downlink resource grant (e.g., in downlink control information (DCI) or other a grant of resources over which to receive PDSCH transmission(s)), to generate the joint CSI feedback report (e.g., for the transmission over the PDSCH and/or one or more CSI-RSs). In another example, the configuration may be transmitted in radio resource control (RRC) or other higher layer signaling. The configuration may indicate parameters for generating the joint CSI feedback reports, such as a number or indication of downlink transmissions for which to report CSI feedback, parameters indicating instructions for generating the first and second parts of the joint CSI feedback report, parameters for determining and/or indicating the reference value or differential values, and/or the like. In this example, CSI demultiplexing component 352 can demultiplex the joint CSI feedback report to generate the CSI feedback reports for the multiple downlink transmissions based on the parameters, and as described above.

FIG. 6 is a block diagram of a MIMO communication system 600 including a base station 102 and a UE 104. The MIMO communication system 600 may illustrate aspects of the wireless communication access network 100 described with reference to FIG. 1. The base station 102 may be an example of aspects of the base station 102 described with reference to FIG. 1. The base station 102 may be equipped with antennas 634 and 635, and the UE 104 may be equipped with antennas 652 and 653. In the MIMO communication system 600, the base station 102 may be able to send data over multiple communication links at the same time. Each communication link may be called a “layer” and the “rank” of the communication link may indicate the number of layers used for communication. For example, in a 2×2 MIMO communication system where base station 102 transmits two “layers,” the rank of the communication link between the base station 102 and the UE 104 is two.

At the base station 102, a transmit (Tx) processor 620 may receive data from a data source. The transmit processor 620 may process the data. The transmit processor 620 may also generate control symbols or reference symbols. A transmit MIMO processor 630 may perform spatial processing (e.g., precoding) on data symbols, control symbols, or reference symbols, if applicable, and may provide output symbol streams to the transmit modulator/demodulators 632 and 633. Each modulator/demodulator 632 through 633 may process a respective output symbol stream (e.g., for OFDM, etc.) to obtain an output sample stream. Each modulator/demodulator 632 through 633 may further process (e.g., convert to analog, amplify, filter, and upconvert) the output sample stream to obtain a DL signal. In one example, DL signals from modulator/demodulators 632 and 633 may be transmitted via the antennas 634 and 635, respectively.

The UE 104 may be an example of aspects of the UEs 104 described with reference to FIGS. 1-2. At the UE 104, the UE antennas 652 and 653 may receive the DL signals from the base station 102 and may provide the received signals to the modulator/demodulators 654 and 655, respectively. Each modulator/demodulator 654 through 655 may condition (e.g., filter, amplify, downconvert, and digitize) a respective received signal to obtain input samples. Each modulator/demodulator 654 through 655 may further process the input samples (e.g., for OFDM, etc.) to obtain received symbols. A MIMO detector 656 may obtain received symbols from the modulator/demodulators 654 and 655, perform MIMO detection on the received symbols, if applicable, and provide detected symbols. A receive (Rx) processor 658 may process (e.g., demodulate, deinterleave, and decode) the detected symbols, providing decoded data for the UE 104 to a data output, and provide decoded control information to a processor 680, or memory 682.

The processor 680 may in some cases execute stored instructions to instantiate a communicating component 242 (see e.g., FIGS. 1 and 2).

On the uplink (UL), at the UE 104, a transmit processor 664 may receive and process data from a data source. The transmit processor 664 may also generate reference symbols for a reference signal. The symbols from the transmit processor 664 may be precoded by a transmit MIMO processor 666 if applicable, further processed by the modulator/demodulators 654 and 655 (e.g., for SC-FDMA, etc.), and be transmitted to the base station 102 in accordance with the communication parameters received from the base station 102. At the base station 102, the UL signals from the UE 104 may be received by the antennas 634 and 635, processed by the modulator/demodulators 632 and 633, detected by a MIMO detector 636 if applicable, and further processed by a receive processor 638. The receive processor 638 may provide decoded data to a data output and to the processor 640 or memory 642.

The processor 640 may in some cases execute stored instructions to instantiate a scheduling component 342 (see e.g., FIGS. 1 and 3).

The components of the UE 104 may, individually or collectively, be implemented with one or more ASICs adapted to perform some or all of the applicable functions in hardware. Each of the noted modules may be a means for performing one or more functions related to operation of the MIMO communication system 600. Similarly, the components of the base station 102 may, individually or collectively, be implemented with one or more application specific integrated circuits (ASICs) adapted to perform some or all of the applicable functions in hardware. Each of the noted components may be a means for performing one or more functions related to operation of the MIMO communication system 600.

The following aspects are illustrative only and aspects thereof may be combined with aspects of other embodiments or teaching described herein, without limitation.

Aspect 1 is a method for wireless communications including receiving, from a base station, at least one of multiple downlink transmissions, generating or determining, for each of the multiple downlink transmissions, a CSI feedback report, generating, based on the CSI feedback reports, a joint CSI feedback report that is of a reduced size from the CSI feedback reports, and transmitting, to the base station, the joint CSI feedback report.

In Aspect 2, the method of Aspect 1 includes where generating the joint CSI feedback report comprises generating a first part of the joint CSI feedback report as reduced size CSI feedback reports of the CSI feedback reports.

In Aspect 3, the method of Aspect 2 includes where the reduced size CSI feedback reports are HARQ feedback values indicating acknowledgement or negative-acknowledgement of receiving a corresponding one of the multiple downlink transmissions.

In Aspect 4, the method of any of Aspects 2 or 3 includes where the reduced size CSI feedback reports are multi-bit HARQ feedback values indicating acknowledgement and a margin of receiving a corresponding one of the multiple downlink transmissions or negative-acknowledgement and a channel condition of receiving the corresponding one of the multiple downlink transmissions.

In Aspect 5, the method of any of Aspects 2 to 4 includes where generating the joint CSI feedback report further comprises generating a second part of the joint CSI feedback report as a statistical report representative of the CSI feedback reports.

In Aspect 6, the method of Aspect 5 includes where the statistical report includes at least one of a number of worst values of the CSI feedback reports, a number of best values of the CSI feedback reports, an average of at least a portion of the CSI feedback reports, or at least one of a mean or variance of at least a portion of the CSI feedback reports.

In Aspect 7, the method of any of Aspects 1 to 6 includes generating, for each of the CSI feedback reports, a CSI feedback value, where generating the joint CSI feedback report comprises generating a first part of the joint CSI feedback report as a reference value of the CSI feedback values, and generating, for each of the CSI feedback reports, a second part of the joint CSI feedback report as differential values of the CSI feedback values based on the reference value.

In Aspect 8, the method of any of Aspects 1 to 7 includes where the multiple downlink transmissions include at least one CSI reference signal or at least one PDSCH signal.

In Aspect 9, the method of any of Aspects 1 to 8 includes receiving, from the base station, a downlink grant with an indication to measure and report CSI feedback for the multiple downlink transmissions, where generating and transmitting the joint CSI feedback report is based on receiving the indication.

In Aspect 10, the method of any of Aspects 1 to 9 includes receiving, from the base station, a configuration indicating to generate joint CSI feedback reports, where generating the joint CSI feedback report is based at least in part on receiving the configuration.

In Aspect 11, the method of Aspect 10 includes where the configuration indicates one or more parameters for generating the joint CSI feedback report.

In Aspect 12, the method of any of Aspects 1 to 11 includes where the CSI feedback reports include one or more of a CRI, a RI, a PMI, or a CQI.

In Aspect 13, the method of any of Aspects 1 to 12 includes where receiving the multiple downlink transmissions includes receiving the multiple downlink transmissions in different time periods.

In Aspect 14, the method of any of Aspects 1 to 13 includes where receiving the multiple downlink transmissions includes receiving the multiple downlink transmissions from different serving cells.

Aspect 15 is a method for wireless communications including transmitting, to a UE, at least one of multiple downlink transmissions, receiving, from the UE, a joint CSI feedback report indicating a CSI feedback report for each of the multiple downlink transmissions, where the joint CSI feedback report is of a reduced size from the CSI feedback reports, and processing the joint CSI feedback report to determine the CSI feedback report for each of the multiple downlink transmissions.

In Aspect 16, the method of Aspect 15 includes where processing the joint CSI feedback report comprises determining a first part of the joint CSI feedback report as reduced size CSI feedback report of the CSI feedback reports.

In Aspect 17, the method of Aspect 16 includes where the reduced size CSI feedback reports are HARQ feedback values indicating acknowledgement or negative-acknowledgement of receiving a corresponding one of the multiple downlink transmissions.

In Aspect 18, the method of any of Aspects 16 or 17 includes where the reduced size CSI feedback reports are multi-bit HARQ feedback values indicating acknowledgement and a margin of receiving a corresponding one of the multiple downlink transmissions or negative-acknowledgement and a channel condition of receiving the corresponding one of the multiple downlink transmissions.

In Aspect 19, the method of any of Aspects 16 to 18 includes where processing the joint CSI feedback report further comprising determining a second part of the joint CSI feedback report as a statistical report representative of the CSI feedback reports.

In Aspect 20, the method of Aspect 19 includes where the statistical report includes at least one of a number of a number of worst values of the CSI feedback reports, a number of best values of the CSI feedback reports, an average of at least a portion of the CSI feedback reports, or at least one of a mean or variance of at least a portion of the CSI feedback reports.

In Aspect 21, the method of any of Aspects 15 to 20 includes where processing the joint CSI feedback report comprises determining a first part of the joint CSI feedback report as a reference CSI feedback value and determining, for each of the CSI feedback reports, a second part of the joint CSI feedback report as differential CSI feedback values from the reference CSI feedback value.

In Aspect 22, the method of any of Aspects 15 to 21 includes where the multiple downlink transmissions include at least one CSI reference signal or at least one PDSCH signal.

In Aspect 23, the method of any of Aspects 15 to 22 includes transmitting, to the UE, a downlink grant with an indication to measure and report CSI feedback for the multiple downlink transmissions, where receiving the joint CSI feedback report is based on transmitting the indication.

In Aspect 24, the method of any of Aspects 15 to 23 includes transmitting, to the UE, a configuration indicating to generate joint CSI feedback reports, where receiving the joint CSI feedback report is based at least in part on transmitting the configuration.

In Aspect 25, the method of Aspect 24 includes where the configuration indicates one or more parameters for generating the joint CSI feedback report.

In Aspect 26, the method of any of Aspects 15 to 25 includes where the CSI feedback reports include one or more of a CRI, a RI, a PMI, or a CQI.

Aspect 27 is a method for wireless communications including receiving, from a base station, two or more downlink transmissions, determine, for each of the two or more downlink transmissions, CSI feedback, generating a joint CSI feedback report that jointly encodes the CSI feedback for each of the two or more downlink transmissions and is of a reduced size from the CSI feedback for the two or more downlink transmissions, and transmitting, to the base station, the joint CSI feedback report.

In Aspect 28, the method of Aspect 27 includes generating the joint CSI feedback report, the joint CSI feedback report comprising at least a first part which includes reduced size CSI feedback, where the reduced size CSI feedback comprises condensed versions of the CSI feedback for each of the two or more downlink transmissions.

In Aspect 29, the method of Aspect 28 includes where the reduced size CSI feedback reports comprise HARQ feedback values indicating acknowledgement or negative-acknowledgement of receiving corresponding ones of the two or more downlink transmissions.

In Aspect 30, the method of Aspect 28 includes where the reduced size CSI feedback reports comprise multi-bit HARQ feedback values indicating acknowledgement and a margin of receiving a corresponding one of the two or more downlink transmissions or negative-acknowledgement and a channel condition of receiving the corresponding one of the two or more downlink transmissions.

In Aspect 31, the method of any of Aspects 28 to 30 where the joint CSI feedback report comprising at least a second part which includes a statistical report representative of the CSI feedback reports.

In Aspect 32, the method of Aspect 31 includes where the statistical report includes at least one of a number of worst values of the CSI feedback, a number of best values of the CSI feedback, an average of at least a portion of the CSI feedback, or at least one of a mean or variance of at least a portion of the CSI feedback.

In Aspect 33, the method of any of Aspects 27 to 32 includes generating, for each of the CSI feedback, a CSI feedback value, and generating the joint CSI feedback report including a first part of the joint CSI feedback report as a reference value of the CSI feedback values, and, for each of the CSI feedback reports, a second part of the joint CSI feedback report as differential values of the CSI feedback values based on the reference value.

In Aspect 34, the method of any of Aspects 27 to 33 includes where the two or more downlink transmissions include at least one CSI reference signal or at least one PDSCH signal.

In Aspect 35, the method of any of Aspects 27 to 34 includes receiving, from the base station, a downlink grant with an indication to measure and report CSI feedback for the two or more downlink transmissions, and generating and transmitting the joint CSI feedback report based on receiving the indication.

In Aspect 36, the method of any of Aspects 27 to 34 includes receiving, from the base station, a configuration indicating to generate joint CSI feedback reports, and generating the joint CSI feedback report based at least in part on receiving the configuration.

In Aspect 37, the method of Aspect 36 includes where the configuration indicates one or more parameters for generating the joint CSI feedback report.

In Aspect 38, the method of any of Aspects 27 to 37 includes where the CSI feedback reports include one or more of a CRI, a RI, a PMI, or a CQI.

In Aspect 39, the method of any of Aspects 27 to 38 includes receiving the two or more downlink transmissions in different time periods.

In Aspect 40, the method of any of Aspects 27 to 39 includes receiving the two or more downlink transmissions from different serving cells.

Aspect 41 is a method for wireless communications including transmitting, to a UE, two or more downlink transmissions, receiving, from the UE, a joint CSI feedback report indicating a CSI feedback for each of the two or more downlink transmissions, where the joint CSI feedback report is of a reduced size from the CSI feedback for the two or more downlink transmissions, and processing the joint CSI feedback report to determine the CSI feedback for each of the two or more downlink transmissions.

In Aspect 42, the method of Aspect 41 includes where the joint CSI feedback report comprising at least a first part which includes reduced size CSI feedback, where the reduced size CSI feedback comprises condensed versions of the CSI feedback for each of the two or more downlink transmissions.

In Aspect 43, the method of Aspect 42 includes where the reduced size CSI feedback reports comprise HARQ feedback values indicating acknowledgement or negative-acknowledgement of receiving a corresponding one of the two or more downlink transmissions.

In Aspect 44, the method of Aspect 42 includes where the reduced size CSI feedback reports comprise multi-bit HARQ feedback values indicating acknowledgement and a margin of receiving a corresponding one of the two or more downlink transmissions or negative-acknowledgement and a channel condition of receiving the corresponding one of the two or more downlink transmissions.

In Aspect 45, the method of any of Aspects 42 to 44 includes where the joint CSI feedback report comprising at least a second part which includes a statistical report representative of the CSI feedback reports.

In Aspect 46, the method of Aspect 45 includes where the statistical report includes at least one of a number of a number of worst values of the CSI feedback, a number of best values of the CSI feedback, an average of at least a portion of the CSI feedback, or at least one of a mean or variance of at least a portion of the CSI feedback.

In Aspect 47, the method of any of Aspects 41 to 46 includes processing the joint CSI feedback report including determining a first part of the joint CSI feedback report as a reference CSI feedback value and, for each of the CSI feedback reports, a second part of the joint CSI feedback report as differential CSI feedback values from the reference CSI feedback value.

In Aspect 48, the method of any of Aspects 41 to 47 includes where the two or more downlink transmissions include at least one CSI reference signal or at least one PDSCH signal.

In Aspect 49, the method of any of Aspects 41 to 48 includes transmitting, to the UE, a downlink grant with an indication to measure and report CSI feedback for the two or more downlink transmissions, and receiving the joint CSI feedback report based on transmitting the indication.

In Aspect 50, the method of any of Aspects 41 to 49 includes transmitting, to the UE, a configuration indicating to generate joint CSI feedback reports, and receiving the joint CSI feedback report based at least in part on transmitting the configuration.

In Aspect 51, the method of Aspect 50 includes where the configuration indicates one or more parameters for generating the joint CSI feedback report.

In Aspect 52, the method of any of Aspects 41 to 51 includes where the CSI feedback reports include one or more of a CRI, a RI, a PMI, or a CQI.

Aspect 53 is an apparatus for wireless communication including a transceiver, a memory configured to store instructions, and one or more processors communicatively coupled with the memory and the transceiver, where the one or more processors are configured to perform one or more of the methods of any of Aspects 1 to 52.

Aspect 54 is an apparatus for wireless communication including means for performing one or more of the methods of any of Aspects 1 to 52.

Aspect 55 is a computer-readable medium including code executable by one or more processors for wireless communications, the code including code for performing one or more of the methods of any of Aspects 1 to 52.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially programmed device, such as but not limited to a processor, a digital signal processor (DSP), an ASIC, a field programmable gate array (FPGA) or other programmable logic device, a discrete gate or transistor logic, a discrete hardware component, or any combination thereof designed to perform the functions described herein. A specially programmed processor may be a microprocessor, but in the alternative, the processor may be any conventional processor, controller, microcontroller, or state machine. A specially programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. An apparatus for wireless communication, comprising:
a transceiver;
a memory configured to store instructions; and
one or more processors communicatively coupled with the memory and the transceiver, wherein the one or more processors are configured to execute the instructions to cause the apparatus to:
receive, from a base station, two or more downlink transmissions;
determine, for each of the two or more downlink transmissions, channel state information (CSI) feedback;
generate a joint CSI feedback report that jointly encodes the CSI feedback for each of the two or more downlink transmissions and is of a reduced size from the CSI feedback for the two or more downlink transmissions; and
transmit, to the base station, the joint CSI feedback report.

2. The apparatus of claim 1, wherein the one or more processors are configured to execute the instructions to cause the apparatus to generate the joint CSI feedback report, the joint CSI feedback report comprising at least a first part which includes reduced size CSI feedback, wherein the reduced size CSI feedback comprises condensed versions of the CSI feedback for each of the two or more downlink transmissions.

3. The apparatus of claim 2, wherein the reduced size CSI feedback reports comprise hybrid automatic repeat/request (HARQ) feedback values indicating acknowledgement or negative-acknowledgement of receiving corresponding ones of the two or more downlink transmissions.

4. The apparatus of claim 2, wherein the reduced size CSI feedback reports comprise multi-bit hybrid automatic repeat/request (HARQ) feedback values indicating acknowledgement and a margin of receiving a corresponding one of the two or more downlink transmissions or negative-acknowledgement and a channel condition of receiving the corresponding one of the two or more downlink transmissions.

5. The apparatus of claim 2, wherein the one or more processors are configured to execute the instructions to cause the apparatus to generate the joint CSI feedback report, the joint CSI feedback report comprising at least a second part which includes a statistical report representative of the CSI feedback reports.

6. The apparatus of claim 5, wherein the statistical report includes at least one of:
a number of worst values of the CSI feedback,
a number of best values of the CSI feedback,
an average of at least a portion of the CSI feedback, or
at least one of a mean or variance of at least a portion of the CSI feedback.

7. The apparatus of claim 1, wherein the one or more processors are further configured to execute the instructions to cause the apparatus to:
generate, for each of the CSI feedback, a CSI feedback value; and
generate the joint CSI feedback report including a first part of the joint CSI feedback report as a reference value of the CSI feedback values, and, for each of the CSI feedback reports, a second part of the joint CSI feedback report as differential values of the CSI feedback values based on the reference value.

8. The apparatus of claim 1, wherein the two or more downlink transmissions include at least one CSI reference signal or at least one physical downlink shared channel (PDSCH) signal.

9. The apparatus of claim 1, wherein the one or more processors are further configured to execute the instructions to cause the apparatus to:
receive, from the base station, a downlink grant with an indication to measure and report CSI feedback for the two or more downlink transmissions; and
generate and transmit the joint CSI feedback report based on receiving the indication.

10. The apparatus of claim 1, wherein the one or more processors are further configured to execute the instructions to cause the apparatus to:
receive, from the base station, a configuration indicating to generate joint CSI feedback reports; and
generate the joint CSI feedback report based at least in part on receiving the configuration.

11. The apparatus of claim 10, wherein the configuration indicates one or more parameters for generating the joint CSI feedback report.

12. The apparatus of claim 1, wherein the CSI feedback reports include one or more of a CSI reference signal resource indicator (CRI), a rank indicator (RI), a precoding matrix indicator (PMI), or a channel quality indicator (CQI).

13. The apparatus of claim 1, wherein the one or more processors are configured to execute the instructions to cause the apparatus to:
receive the two or more downlink transmissions in different time periods.

14. The apparatus of claim 1, wherein the one or more processors are configured to execute the instructions to cause the apparatus to:
receive the two or more downlink transmissions from different serving cells.

15. An apparatus for wireless communication, comprising:
a transceiver;
a memory configured to store instructions; and
one or more processors communicatively coupled with the memory and the transceiver, wherein the one or more processors are configured to execute the instructions to cause the apparatus to:
transmit, to a user equipment (UE), two or more downlink transmissions;
receive, from the UE, a joint channel state information (CSI) feedback report indicating a CSI feedback for each of the two or more downlink transmissions, wherein the joint CSI feedback report is of a reduced size from the CSI feedback for the two or more downlink transmissions; and
process the joint CSI feedback report to determine the CSI feedback for each of the two or more downlink transmissions.

16. The apparatus of claim 15, wherein the one or more processors are configured to execute the instructions to cause the apparatus to:
process the joint CSI feedback report, the joint CSI feedback report comprising at least a first part which includes reduced size CSI feedback, wherein the reduced size CSI feedback comprises condensed versions of the CSI feedback for each of the two or more downlink transmissions.

17. The apparatus of claim 16, wherein the reduced size CSI feedback reports comprise hybrid automatic repeat/request (HARQ) feedback values indicating acknowledgement or negative-acknowledgement of receiving a corresponding one of the two or more downlink transmissions.

18. The apparatus of claim 16, wherein the reduced size CSI feedback reports comprise multi-bit hybrid automatic repeat/request (HARQ) feedback values indicating acknowledgement and a margin of receiving a corresponding one of the two or more downlink transmissions or negative-acknowledgement and a channel condition of receiving the corresponding one of the two or more downlink transmissions.

19. The apparatus of claim 16, wherein the one or more processors are configured to execute the instructions to cause the apparatus to:
process the joint CSI feedback report, the joint CSI feedback report comprising at least a second part which includes a statistical report representative of the CSI feedback reports.

20. The apparatus of claim 19, wherein the statistical report includes at least one of a number of
a number of worst values of the CSI feedback,
a number of best values of the CSI feedback,
an average of at least a portion of the CSI feedback, or
at least one of a mean or variance of at least a portion of the CSI feedback.

21. The apparatus of claim 15, wherein the one or more processors are configured to execute the instructions to cause the apparatus to:
process the joint CSI feedback report including determining a first part of the joint CSI feedback report as a reference CSI feedback value and, for each of the CSI feedback reports, a second part of the joint CSI feedback report as differential CSI feedback values from the reference CSI feedback value.

22. The apparatus of claim 15, wherein the two or more downlink transmissions include at least one CSI reference signal or at least one physical downlink shared channel (PDSCH) signal.

23. The apparatus of claim 15, wherein the one or more processors are further configured to execute the instructions to cause the apparatus to:
transmit, to the UE, a downlink grant with an indication to measure and report CSI feedback for the two or more downlink transmissions; and
receive the joint CSI feedback report based on transmitting the indication.

24. The apparatus of claim 15, wherein the one or more processors are further configured to execute the instructions to cause the apparatus to:
transmit, to the UE, a configuration indicating to generate joint CSI feedback reports; and
receive the joint CSI feedback report based at least in part on transmitting the configuration.

25. The apparatus of claim 24, wherein the configuration indicates one or more parameters for generating the joint CSI feedback report.

26. The apparatus of claim 15, wherein the CSI feedback reports include one or more of a CSI reference signal resource indicator (CRI), a rank indicator (RI), a precoding matrix indicator (PMI), or a channel quality indicator (CQI).

27. A method for wireless communications, comprising:
receiving, from a base station, two or more downlink transmissions;
determining, for each of the two or more downlink transmissions, channel state information (CSI) feedback;
generating a joint CSI feedback report that jointly encodes the CSI feedback for each of the two or more downlink transmissions and is of a reduced size from the CSI feedback for the two or more downlink transmissions; and
transmitting, to the base station, the joint CSI feedback report.

28. The method of claim 27, wherein the joint CSI feedback report comprises at least a first part which includes reduced size CSI feedback, wherein the reduced size CSI feedback comprises condensed versions of the CSI feedback for each of the two or more downlink transmissions.

29. A method for wireless communications, comprising:
transmitting, to a user equipment (UE), two or more downlink transmissions;
receiving, from the UE, a joint channel state information (CSI) feedback report indicating a CSI feedback for each of the two or more downlink transmissions, wherein the joint CSI feedback report is of a reduced size from the CSI feedback for the two or more downlink transmissions; and
processing the joint CSI feedback report to determine the CSI feedback for each of the two or more downlink transmissions.

30. The method of claim 29, wherein the joint CSI feedback report comprises at least a first part which includes reduced size CSI feedback, wherein the reduced size CSI feedback comprises condensed versions of the CSI feedback for each of the two or more downlink transmissions.
